(19) United States
(12) Patent Application Publication
(10) Pub. No.: US 2007/0145037 A1
(43) Pub. Date: Jun. 28, 2007

(54) Electro-heating device

(75) Inventors: Han-Hsing Hsiung, Hsinchu Hsien (TW); Chi-Shu Wei, Panchiao City (TW)

Correspondence Address: Robert F. Gazdzinski, Esq.;Gazdzinski & Associates, Suite 375, 11440 West Bernardo Court, San Diego, CA, 92127, US

(73) Assignee: TAIWAN TEXTILE RESEARCH INSTITUTE, Taipei Hsien (TW)

(21) Appl. No.: 11/540,323

(22) Filed: Sep. 28, 2006

(30) Foreign Application Priority Data
Dec. 28, 2005 (TW) 94147071

(51) Int. Cl. H05B 3/34

(52) U.S. Cl. 219/529

(57) ABSTRACT

An electro-heating device is provided. The electro-heating device comprises a conductive material and an electro-heating resin. The electro-heating resin is coated on the surface of the conductive material. The material of the electro-heating resin is preferably a conductive resin.

### RELATED APPLICATIONS

The present application is based on, and claims priority from, Taiwan Application Serial Number 94147071, filed Dec. 28, 2005, the disclosure of which is hereby incorporated by reference herein in its entirety.

### BACKGROUND

1. Field of Invention

The present invention relates to an electro-heating device. More particularly, the present invention relates to an electro-heating device with accumulated-heating effect.

2. Description of Related Art

With increases in living quality, demand for functional textiles, such as those that absorb moisture, repel water, are breathable, are comfortable, and are thermally insulative, has been raised. Due to the arrival of old-aging society, demands of various healthy textiles are increased, especially those used in cold weather. Therefore, design efforts are primarily focused upon lightweight and insulative clothing that can keep people warm.

Electro-heating textiles were innovated to overcome this limitation. Conductive fibers are formed by spinning conductive materials with general fibers or coating a conductive layer on general fibers, which are then woven into a general nonconductive textile to form an electro-heating textile. However, electro-heating textiles produced by the conventional methods have two critical problems: non-uniform temperature distribution and poor heating accumulation. Moreover, the conductive material is stiffer than the general fibers so that softness of the conductive textile is reduced and difficulties of manufacturing the conductive textile are increased. The conductive materials easily separate from the textile because of poor adhesive force between the conductive materials and the fibers. Furthermore, the traditional electro-heating textile has poor water resistance so that the conductive materials of the electro-heating textile easily oxidize and corrode.

Thus, an improved electro-heating textile is desired, which has accumulated-heating effect, uniform temperature distribution, and well-waterproof function to solve these problems.

### SUMMARY

In one aspect, this present invention provides an electro-heating device offering increased heating accumulation over the prior art.

In another aspect, this present invention provides an electro-heating device to enhance heating speed of the electro-heating textile and provide a uniform heating surface on the electro-heating device.

In yet another aspect, this present invention provides a washable electro-heating device that provides heating accumulation and waterproofing functionality.

In accordance with the foregoing and other aspects of the present invention, the present invention provides an electro-heating yarn, which comprises a conductive yarn and an electro-heating resin, wherein the electro-heating resin is coated on the conductive yarn. The material of the electro-heating resin is preferably a conductive resin. According to one embodiment of the present invention, a waterproof layer is coated on a surface of the electro-heating yarn to form a washable electro-heating yarn.

According to one embodiment of the present invention, the electro-heating yarn can be woven an electro-heating textile. According to one embodiment of the present invention, a waterproof layer is coated on a surface of the electro-heating textile to form a washable electro-heating textile.

It is another aspect of the present invention to provide an electro-heating device, which comprises a conductive textile and an electro-heating resin, wherein the electro-heating resin is coated on the conductive textile. The material of the electro-heating resin is preferably a conductive resin. According to one embodiment of the present invention, a waterproof layer is coated on a surface of the electro-heating device to form a washable electro-heating device.

Thus, the present invention uses an electro-heating resin coated on a conductive device to form an electro-heating device to enhance heating accumulation of the electro-heating device. Moreover, the present invention has the characteristics of larger heating speed, which is up to 5° C. per thirty seconds, and of larger temperature range, which is between 30° C. and 100° C. Furthermore, the electro-heating device of the present invention further comprises a waterproof layer coated on an electro-heating resin to form a washable electro-heating device to improve its utilization.

### BRIEF DESCRIPTION OF THE DRAWINGS

The invention can be more fully understood by reading the following detailed description of the preferred embodiment, with reference made to the accompanying drawings as follows:

FIG. 1 is a schematic diagram showing an electro-heating yarn according to one embodiment of the present invention.

FIGS. 1A and 1B are schematic diagrams showing a washable electro-heating textile according to one embodiment of the present invention.

FIG. 2 is a schematic diagram showing a washable electro-heating yarn according to one embodiment of the present invention.

FIGS. 2A and 2B are schematic diagrams showing a washable electro-heating textile according to one embodiment of the present invention.

FIGS. 3A and 3B are schematic diagrams showing a washable electro-heating textile according to another embodiment of the present invention.

### DETAILED DESCRIPTION

The present invention provides an electro-heating device to enhance heating accumulation of the electro-heating device. The electro-heating device comprises a conductive material and an electro-heating resin coated thereon. A material of the conductive material is preferably carbon, stainless steel, Au, Ag, Cu, Fe, Ni, or alloy.

The material of the electro-heating resin is preferably a conductive resin. The conductive resin preferably consists of a conductive material and a resin. The electrical resistance range of the conductive resin is preferably from 1 ohm-cm to 10¹⁰ ohm-cm. The weight percentage of the conductive material of the conductive resin is preferably between 1% and 50% according to one embodiment of the present invention. The material of the conductive material is preferably conductive carbon black, conductive polymer, or metal.

Moreover, a waterproof layer is coated on a surface of the electro-heating device to form a washable electro-heating device. The material of the waterproof layer is preferably polyurethane, silica gel, polyamide, polyimide, polyamide-imide, epoxy resin, polyvinyl chloride, or acrylic acid.

The electro-heating device can be an electro-heating yarn or an electro-heating textile according to embodiment of the present invention. The following description describes different preferred embodiments of the present invention that represent different layouts. However, the layouts of the electro-heating device can be further adjusted according to the demands.

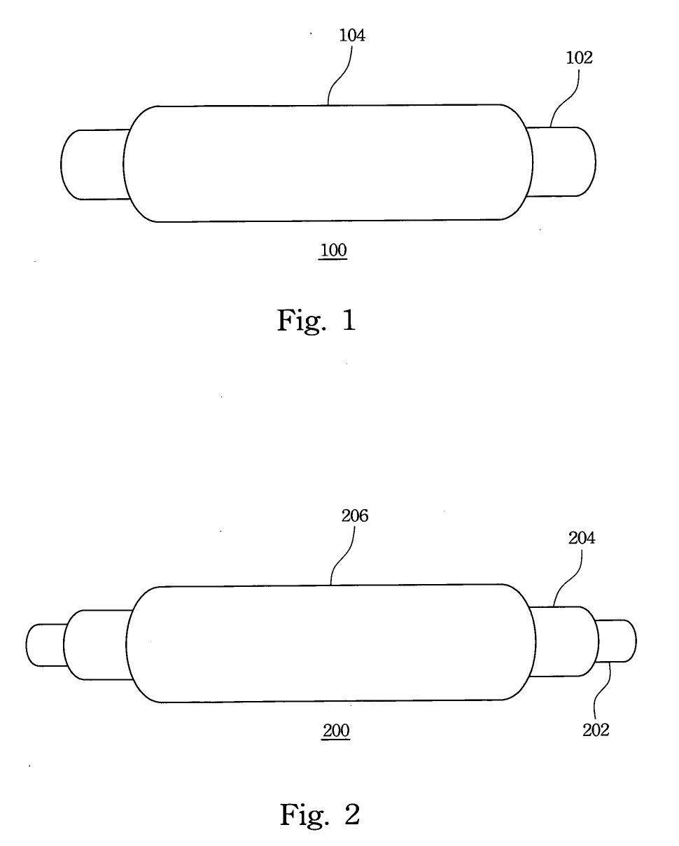

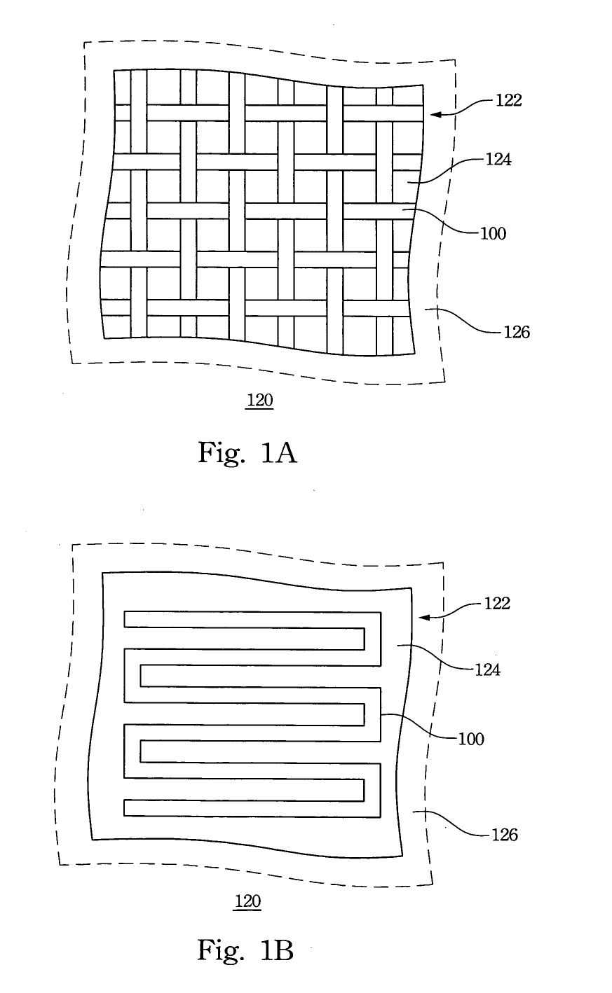

FIG. 1 is a schematic diagram showing an electro-heating yarn as the electro-heating device according to one embodiment of the present invention. In FIG. 1, an electro-heating yarn 100 comprises a conductive yarn 102 and an electro-heating resin 104. The electro-heating resin 104 is coated on a surface of the conductive yarn 102.

FIGS. 1A and 1B are schematic diagrams showing a washable electro-heating textile according to one embodiment of the present invention. In FIG. 1A, the electro-heating yarn 100 can be woven uniformly on a textile according to the demands. Alternatively, in FIG. 1B, the electro-heating yarn 100 is not interlaced on the textile 124. In FIG. 1A, an electro-heating textile 122 consists of a textile 124 and the electro-heating yarn 100 shown in FIG. 1. The electro-heating yarn 100 can be woven on the textile 124 as different layouts according to the demands. The surface of the electro-heating textile 122 further comprises a waterproof layer 126 coated thereon to form a washable electro-heating textile 120.

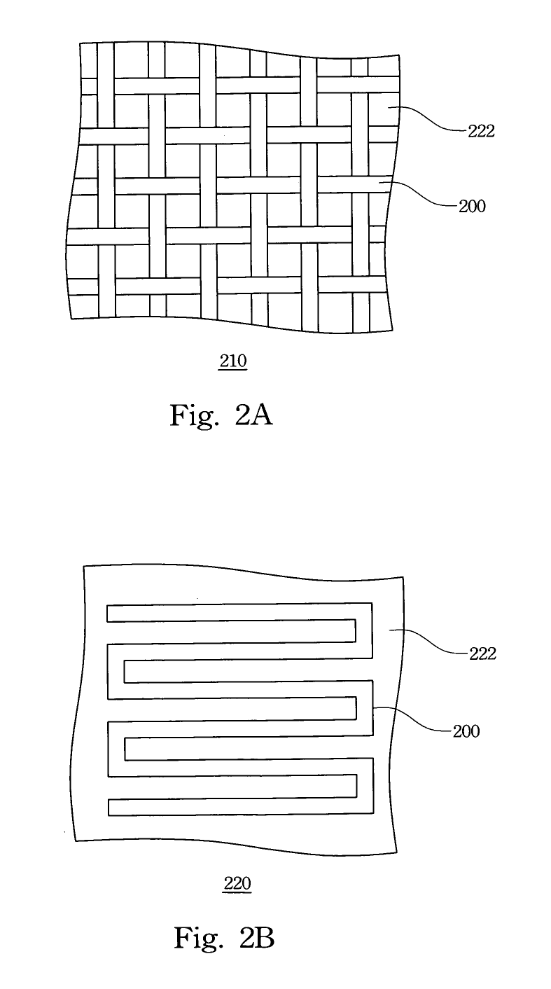

FIG. 2 is a schematic diagram showing a washable electro-heating yarn according to one embodiment of the present invention. In FIG. 2, a washable electro-heating yarn 200 comprises a conductive yarn 202, an electro-heating resin 204 and a waterproof layer 206. The electro-heating resin 204 is coated on the conductive yarn 202. The waterproof layer 206 is coated on the electro-heating resin 204.

FIGS. 2A and 2B are schematic diagrams showing a washable electro-heating textile according to one embodiment of the present invention. In FIG. 2A, a washable electro-heating textile 210 is woven from the washable electro-heating yarn 200 shown in FIG. 2. Alternatively, the washable electro-heating yarn 200 can be woven uniformly on a textile according to the demands. In FIG. 2B, a washable electro-heating textile 220 comprises a textile 222 and the washable electro-heating yarn 200 shown in FIG. 2. The washable electro-heating yarn 200 is woven uniformly on the textile 222. The washable electro-heating yarn 200 can be woven on the textile 222 as different layouts according to the demands.

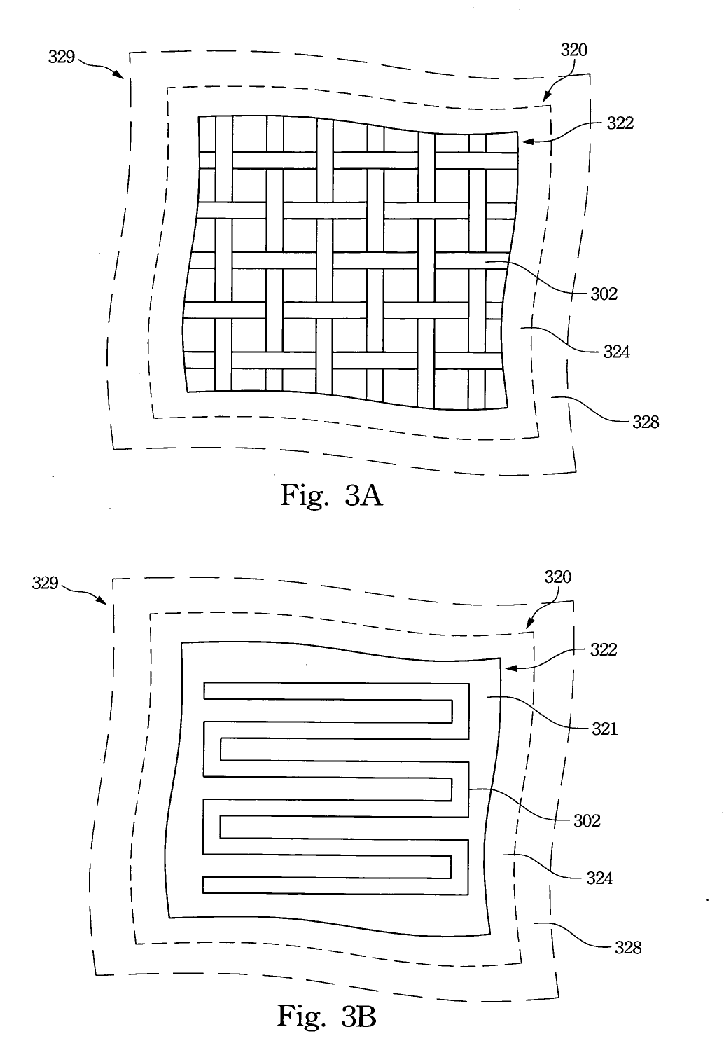

FIGS. 3A and 3B are schematic diagrams showing a washable electro-heating textile according to another embodiment of the present invention. In FIGS. 3A and 3B, an electro-heating textile 320 comprises a conductive textile 322 and an electro-heating resin layer 324. The electro-heating resin layer 324 is coated on a surface of the conductive textile 322. In FIG. 3A, the conductive material 302 can be woven uniformly on a textile according to the demands. Alternatively, in FIG. 3B, the conductive textile 322 comprises a conductive material 302 that is not interlaced and woven uniformly on a textile 321. The layout of the conductive textile 322 can be adjusted according to the demands. The surface of the electro-heating textile 320 further comprises a waterproof layer 328 coated thereon to form a washable electro-heating textile 329.

The electro-heating device was produced according to this embodiment of the present invention and a traditional electro-heating device were subjected to an electric resistance test and a heating speed test. The results are listed in the following Table 1 to Table 3, which represent different electro-heating devices formed by different content of the electro-heating resin.

### Electrical Resistance Test and Heating Speed Test 1

TABLE 1
Electric resistance test and heating speed test of electro-heating yarn

| | Traditional | This electro-heating |
|---|---|---|
| | electro-heating yarn | yarn |
| Resistivity | 10¹ | 10² |
| (ohm/10 cm) | | |
| Heating Speed | 3 | 5 |
| (° C./30 sec) | | |
| Highest Temperature | 32.0 | 37.6 |
| (° C.) | | |

The electro-heating yarn and the traditional electro-heating yarn consist of 6,000 fibers respectively. The surface electric resistance of the electro-heating resin in the electro-heating yarn is 10³ ohm-cm. The electro-heating resin comprises conductive carbon black, silica gel, and conductive polymer with the preferred weight percentage of 8%, 16% and 76%.

From the result above, the electro-heating yarn produced according to this embodiment of the present invention has much larger resistivity, larger heating speed, and larger controllable highest temperature.

### Electrical Resistance Test and Heating Speed Test 2

TABLE 2
Electric resistance test and heating speed test of electro-heating yarn

| | Traditional | This electro-heating |
|---|---|---|
| | electro-heating yarn | yarn |
| Resistivity | 10¹ | 10² |
| (ohm/10 cm) | | |
| Heating Speed | 3 | 5 |
| (° C./30 sec) | | |
| Highest Temperature | 38.0 | 42.0 |
| (° C.) | | |

The electro-heating yarn and the traditional electro-heating yarn consist of 12,000 fibers respectively. The surface electrical resistance of the electro-heating resin in the electro-heating yarn is 10³ ohm-cm. The electro-heating resin comprises conductive carbon black, silica gel, and conductive polymer with the preferred weight percentage of 8%, 16% and 76%.

From the results above, the electro-heating yarn produced according to this embodiment of the present invention has much larger resistivity, larger heating speed, and larger controllable highest temperature.

Furthermore, from the results shown in Table 1 and Table 2, the electro-heating yarn consisting of 12,000 fibers has larger controllable highest temperature than the conductive yarn consisting of 6,000 fibers of the same content of electro-heating resin of the electro-heating yarn. Thus, the conductive yarn having more fibers has larger controllable highest temperature.

### Electrical Resistance Test and Heating Speed Test 3

TABLE 3
Electric resistance test and heating speed test of electro-heating yarn

| | Traditional | This electro-heating |
|---|---|---|
| | electro-heating yarn | yarn |
| Resistivity | 10¹ | 10⁵–10⁶ |
| (ohm/10 cm) | | |
| Heating Speed | 3 | 5 |
| (° C./30 sec) | | |
| Highest Temperature | 38.0 | 80.0 |
| (° C.) | | |

The electro-heating yarn and the traditional electro-heating yarn consist of 12,000 fibers respectively. The surface electrical resistance of the electro-heating resin in the electro-heating yarn is 10⁶ ohm-cm. The electro-heating resin comprises conductive carbon black, silica gel, and conductive polymer with preferred weight percentages of 2%, 38% and 60%.

From the results above, the electro-heating yarn produced according to this embodiment of the present invention has much larger resistivity, larger heating speed, and larger controllable highest temperature.

Thus, the present invention uses an electro-heating resin coated on a conductive device to form an electro-heating device to enhance heating accumulation of the electro-heating device. Moreover, the present invention has the characteristics of larger heating speed, which is up to 5° C. per thirty seconds, and of larger temperature range, which is between 30° C. and 100° C. Furthermore, the electro-heating device of the present invention further comprises a waterproof layer coated on an electro-heating resin to form a washable electro-heating device to improve its utilization.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electro-heating yarn, the electro-heating yarn comprising:
a conductive yarn; and
an electro-heating resin coating the conductive yarn to form the electro-heating yarn, wherein a material of the electro-heating resin comprises a conductive resin.

2. The electro-heating yarn of claim 1, further comprising a waterproof layer covering a surface of the electro-heating yarn.

3. The electro-heating yarn of claim 2, wherein a material of the waterproof layer is selected from a group consisting of polyurethane, silica gel, polyamide, polyimide, polyamide-imide, epoxy resin, polyvinyl chloride, and acrylic acid.

4. The electro-heating yarn of claim 1, wherein a material of the conductive yarn is selected from a group consisting of carbon, stainless steel, Au, Ag, Cu, Fe, Ni and alloy thereof.

5. The electro-heating yarn of claim 1, wherein the conductive resin consists of a conductive material and a resin.

6. The electro-heating yarn of claim 5, wherein a weight percentage of the conductive material of the conductive resin is between 1% and 50%.

7. The electro-heating yarn of claim 5, wherein the conductive material comprises a conductive carbon black, a conductive polymer, and a metal.

8. The electro-heating yarn of claim 1, wherein a resistance range of the conductive resin is between 1 ohm-cm and 10¹⁰ ohm-cm.

9. An electro-heating device, the electro-heating device comprising:
a conductive textile; and
an electro-heating resin covering the conductive textile, wherein materials of the electro-heating resin comprise a conductive resin.

10. The electro-heating device of claim 9, further comprising a waterproof layer covering a surface of the electro-heating resin.

11. The electro-heating device of claim 10, wherein a material of the waterproof layer is selected from a group consisting of polyurethane, silica gel, polyamide, polyimide, polyamide-imide, epoxy resin, polyvinyl chloride, and acrylic acid.

12. The electro-heating device of claim 9, wherein the conductive textile comprises a conductive yarn.

13. The electro-heating device of claim 12, wherein a material of the conductive yarn is selected from a group consisting of carbon, stainless steel, Au, Ag, Cu, Fe, Ni, and alloy thereof.

14. The electro-heating device of claim 9, wherein the conductive resin consists of a conductive material and a resin.

15. The electro-heating device of claim 14, wherein a weight percentage of the conductive resin of the conductive material is between 1% and 50%.

16. The electro-heating device of claim 14, wherein the conductive material comprises a conductive carbon black, a conductive polymer, and a metal.

17. The electro-heating device of claim 9, wherein a resistance range of the conductive resin is between 1 ohm-cm and 10¹⁰ ohm-cm.
